(19) United States
(12) Patent Application Publication
(10) Pub. No.: US 2010/0268580 A1
(43) Pub. Date: Oct. 21, 2010

(54) NETWORK-BASED SIMULATED PACKAGE FOR ENCLOSING DIGITAL OBJECTS

(75) Inventor: John D. Vermes, Palo Alto, CA (US)

Correspondence Address: PERKINS COIE LLP, P.O. BOX 1208, SEATTLE, WA, 98111-1208, US

(73) Assignee: Lyryq, Inc., Palo Alto, CA (US)

(21) Appl. No.: 12/729,097

(22) Filed: Mar. 22, 2010

Related U.S. Application Data
(60) Provisional application No. 61/162,222, filed on Mar. 20, 2009.

(51) Int. Cl. G06F 15/16; G06F 21/00; G06Q 30/00

(52) U.S. Cl. 705/14.1; 709/236; 726/3; 705/27

(57) ABSTRACT

The present disclosure provides methods and systems for bundling and presenting digital information within a network environment by simulating a physical package. In one embodiment, the simulated package has an outer package level to present ancillary information about digital objects enclosed in the simulated package. An inner content level contains the digital objects of the package. In some instances, the inner content level also presents privileges, proxies, promotions, etc. in association with the user's ownership interest in the simulated package. The simulated package also includes an identifier to uniquely associate it with a specific user and to enable the simulated package to function as a unique instance. Also presented are methods and systems to manage the identifiers and to lookup and transfer requests from users to appropriate retailers hosting the simulated packages.

### CROSS-REFERENCE TO RELATED APPLICATIONS

This application claims the benefit of U.S. Provisional Application No. 61/162,222, entitled “NETWORK-BASED SIMULATED PACKAGE FOR ENCLOSING DIGITAL OBJECTS”, filed Mar. 20, 2009, and is hereby incorporated by reference in its entirety.

### FIELD

The following disclosure generally relates to simulating physical packages for enclosing, enhancing the appeal of, and bundling of digital objects. More particularly, the disclosure pertains to methods and systems for using network-based simulated packages for packaging digital objects and maintaining the simulated packages as unique instances within a network environment.

### BACKGROUND

A cover, as illustrated herein, consists of the substrate and external indicia of the packaging of a commercially-released product. For example, an album cover consists of the substrate and indicia of the packaging of an audio recording product (or simply, an “album”). Such a cover, generally used in conjunction with packaging of physical articles, includes examples such as printed cardboard for an album record, or a CD casing together with associated indicia visible in the unopened state (also called a “jewel box”), etc.

Packaging and package covers are advantageous for several reasons. First, they function as a vital tool to advertise the contents of the products enclosed within the package. Second, packages allow the owner of the contents to include promotional materials (e.g., a pinup poster of the artists of a music album, etc.), making the package experience more commercially enticing to a consumer than the individual contents without the packaging.

Additionally, the owner of the individual contents is able to sell all the products or contents within the package as a bundled unit, potentially establishing a more commercially enticing bundle (or package) for the group of products. For example, when making an album commercially available, it contains recordings representing a plurality of musical works, the owner (or a digital rights holder) of the album is able to sell all the musical works of the album as a packaged unit, thus establishing an overall package or bundle value for the album. Where the packages are sufficiently aesthetic and enticing to a consumer, the consumer may be induced to pay a premium based on the perceived synergy of the overall package experience (i.e., the cover, the products within the package, promotional materials, etc.).

Consider the following example that illustrates the incremental value and impact of product packaging vs. its contents alone. In 1971, the Rolling Stones® released an album, Sticky Fingers®, the cover of which was to become famous for its outrageous use of a real working zipper embedded in a representation of a tight-jeaned torso. Thirty-two years later, VH1 named the cover itself the greatest of all time.

Of course, physical packages and package covers cannot play a role in the online marketing and sales of digital products, which include streaming or downloadable media (e.g., MP3 files, video files, electronic books, software executable files such as an installation file for a tax preparation software, etc.). Unfortunately, such digital products appear to be displacing analogous physical products (e.g., music CDs or DVDs sold by digital rights holders) in the market. Typically, digital products are sold to users piecemeal, without any attempt to simulate a package experience such as a user might derive from a physical embodiment of the products.

In an illustrative example, music albums are available as streaming or downloadable (e.g., MP3 files) media by several online retailers. These retailers allow each musical work within a music album to be purchased separately, but do not offer such musical works in a unified digitally bundled format together with an interactive package experience.

It should be noted that while some retailers offer music album covers to accompany some digital music albums, such covers are typically no more than digital images (e.g., JPEG images), downloaded separately along with the plurality of music files that comprise the digital album. While such digital images may be displayed on a media player when the user plays a musical work from the album, this experience is not interactive, and thus sharply limits the options of rights holders to embellish the album.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an embodiment of an overall system for bundling and presenting digital information within a network environment;

FIG. 2 depicts an exemplary embodiment of a simulated package;

FIG. 3 is an exemplary snapshot of the outer package and inner content levels of a simulated package;

FIG. 4 is a flow diagram depicting a method by which a user can access the contents of a simulated package;

FIG. 5 is a flow diagram illustrating a method by which the digital contents embedded in a simulated package are made available to a user;

FIG. 6 is a flow diagram depicting a method by which a management server generates and maintains identifiers for the network-based simulated packages; and

FIG. 7 is a high-level block diagram showing an example of the architecture for a computer system

### SUMMARY OF THE DESCRIPTION

At least one embodiment of this disclosure pertains to bundling and presenting digital information within a network environment in the form of a simulation of a physical package, serving to enclose one or more digital products. In one embodiment, the simulated package has a dual mode of presentation as described below.

The simulated physical package has an outer package level, which may, in turn, be considered as a simulation of the enclosure substrate and indicia of a physical package. In some instances, the outer package level includes ambient music, animation, samples and previews of digital contents of the simulated physical package, etc. The outer package level also provides to the user an option to purchase the simulated package and also to enter authentication information to gain access to the inner digital contents of the simulated package. The outer package level is available without any restrictions to any user of the network environment.

The simulated package also has an inner content level, which may be considered as an equivalent to the actual contents or products of a physical package. In some instances, the inner content level includes the digital products or objects (e.g., music files, software executable files, etc.) that a digital rights holder has an interest in. The inner content level, in some instances, also includes a media player to enable the user to playback or perform other operations using the digital objects. In some instances, the inner content level also includes privileges, promotions, and/or proxies to physical products, providing the user the synergy and added value of a real package experience.

In some instances, the simulated package includes an identifier to uniquely associate the simulated package with a specific user. Additionally, the identifier also enables each simulated package to function as a unique instance within the network environment.

Another embodiment of the present disclosure pertains to methods and systems for managing the simulated packages within a network environment. In some instances, a management server is utilized to maintain unique identifiers for each of the simulated packages hosted by one or more retailers. The retailers, in some instances, generate simulated packages and host such simulated packages using related retailer servers. The management server generates unique identifiers for the retailer server when the retailer server makes a request for such identifiers. The retailer server then associates one of the identifiers generated by the management server with a respective single instance of a specific simulated package.

The retailer server, in some instances, also generates links for each of the simulated packages. The links incorporate the unique identifier that associates the simulated package with a user that purchased the simulated package and also with the retailer server hosting the simulated package. When a user clicks on one of the links, the request is received by the management server. The management server looks up the identifier incorporated in the link and accordingly transfers the user to the pertinent retailer server.

When the retailer server receives the redirected request, it presents to the user the outer package level of the simulated package. The user may then present his authentication information to gain access to the inner content level of the simulated package.

Other advantages and features will become apparent from the following description and claims. It should be understood that the description and specific examples are intended for purposes of illustration only and not intended to limit the scope of the present disclosure.

### DETAILED DESCRIPTION

The present invention may be embodied in several forms and manners. The description provided below and the drawings show exemplary embodiments of the invention. Those of skill in the art will appreciate that the invention may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

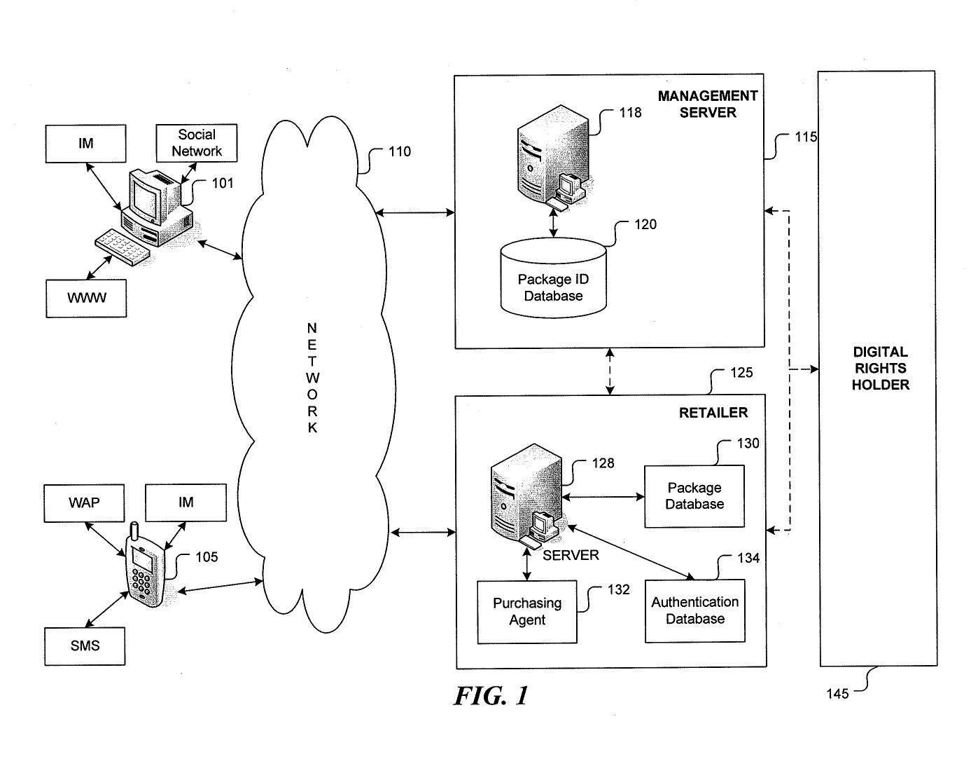

FIG. 1 illustrates an embodiment of an overall system for packaging, bundling and presenting digital information within a network environment. In one embodiment, a user wishing to access the digital information uses a personal network terminal device, such as a personal computer 101 or a mobile device 105. In some instances, the user may access the digital information (e.g., a digital media package), by accessing a link associated with the digital information. In one example, the user may access the link by clicking on the link from a social network displaying the link. In another example, the user may access the link by clicking on the link from a webpage displayed within a network browser of the personal computer 101. In another example, the user may access the link by clicking on the link from within an interactive messaging (e.g., AOL® Chat, Yahoo® Chat, etc.) environment.

In some instances, the user may access the link using a mobile device 105. In one example, the mobile device 105 is equipped with Wireless Application Protocol (WAP) features, thus allowing the mobile device 105 to communicate within an internet based network environment. A user may use this capability to access a webpage or content associated with the digital information and after one or a plurality of further steps access a link associated with the digital information. In some instances, the user may also access the digital information by transmitting an SMS message to a contact number associated with the digital information. Other means and methods of accessing information within a mobile device environment or a personal computing environment, as known to one of ordinary skill in the art, may be used as well. Additionally, in some instances, the user may also use the personal computing device 101 or the mobile device 105, acting as a network terminal device, to forward either the link or information related to the link to a third party in the form of text, for example via e-mail or messaging service within an interactive messaging environment.

In some instances, the user may use the personal computing device 101 or the mobile device 105 to access information hosted by a retailer 125 of the digital information. Such information may include, for example, a product SKU page of the digital information hosted by the retailer 125, etc. Detailed information on the retailer 125 and operations related to the retailer are discussed in greater detail below.

The personal computing device 101 or the mobile device 105, acting as a network terminal device, communicates with other devices in the environment by means of a network 110. The network 110, in some instances, includes the public internet, which may be used to access other devices connected to and communicating with the public internet. In some instances, the network 110 may also include a local area network or a wide area network within which the various devices are connected. As an example, the network 110 may include a public wireless network, e.g. a GSM network.

In one embodiment, the digital information comprises a one or a plurality of different digital objects. The digital objects include, for example, digital media (e.g., MP3 format digital media, digital video tracks, electronic books, etc.) or other digital products (e.g., software executables, etc.) offered by respective owners of such digital objects. The owners of the digital objects, namely the digital rights holders, hold one or a plurality of rights, interests in, or predilections for such digital objects and release the digital objects to consumers subject to such rights or interests.

In one embodiment, one or a plurality of digital objects (e.g., tracks in the MP3 format representing a particular musical work or collection of musical works, e.g. a music album) are bundled together and presented to a user over a network as a package. Such a package, intended to simulate a physical package, comprises a dual mode of presentation. The simulated package has an outer package level (or a cover level) that operates as a virtual package cover to present information related to the contents of the package to a user. The simulated package further comprises an inner content level that includes the digital contents.

Subsequent to activating the presentation of the inner content level of the simulated package, a user can perform operations on or using the digital content (e.g., play an MP3 track included in the inner content level, download a video file included in the inner content level, install a software program using an executable software installer included in the inner content level, etc.). In some instances, the outer package level of the simulated package is available to any user of the networking environment without any access restrictions. However, access to the inner content level of the simulated package may be restricted based on criteria set forth by either a digital rights holder of the digital content, or a retailer hosting the simulated package.

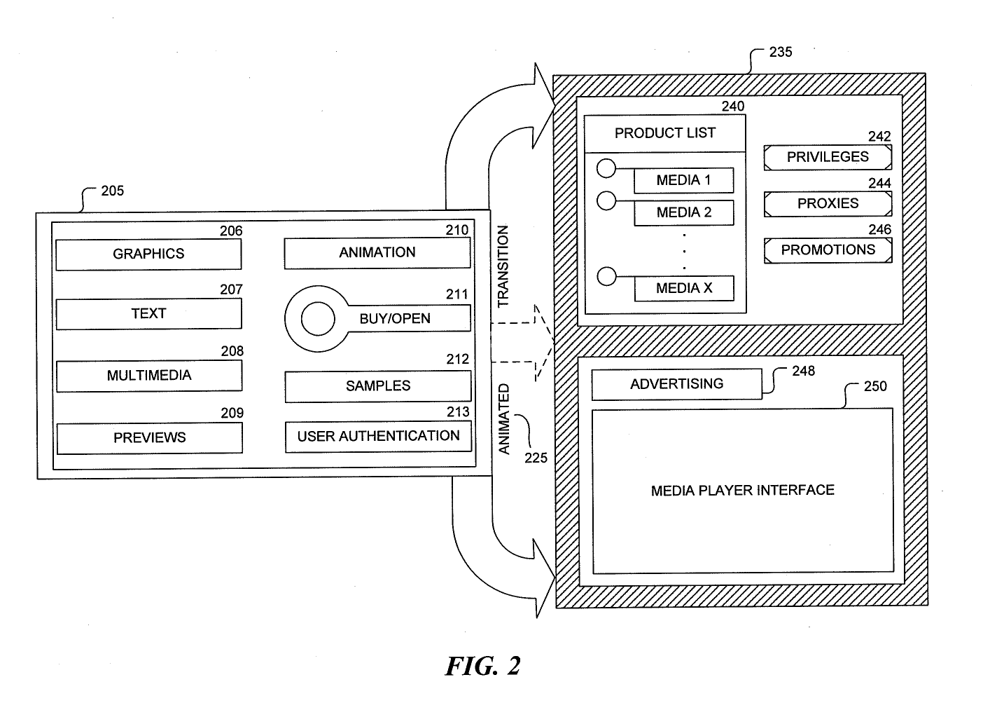

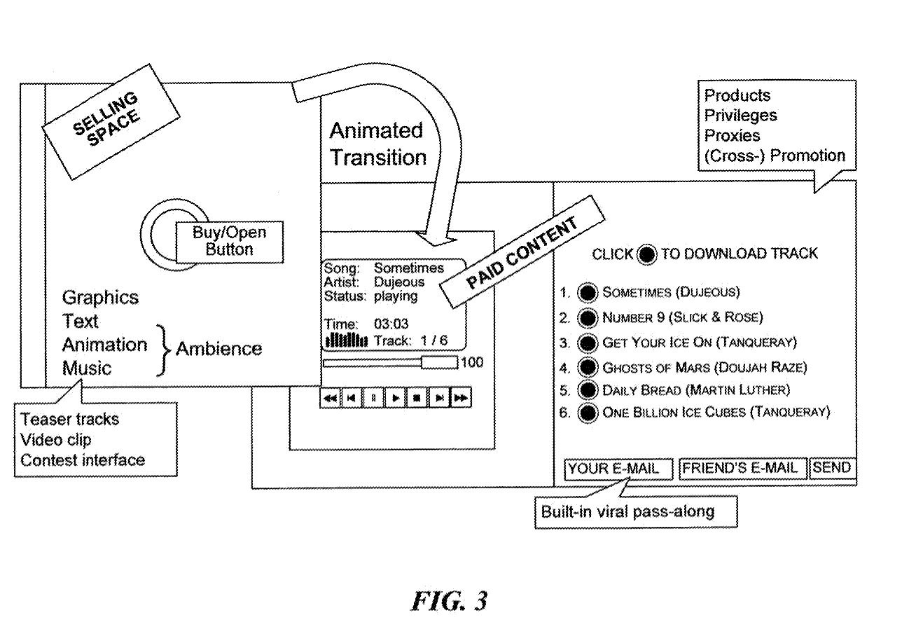

Additionally, each simulated package includes an identifier that allows a unique association of a simulated package to be made with a particular user. Such an identifier also enables each simulated package to function as a unique instance within the network environment. Detailed description of the simulated package and its various functionalities will be discussed more comprehensively with reference to FIGS. 2 and 3 below.

FIG. 1 further illustrates a retailer 125 that may host and offer digital information on behalf of a digital rights holder of the digital information. In some instances, the retailer 125 generates and hosts simulated packages for digital contents (in which a digital rights holder 145 holds a right or interest or predilection). The retailer 125 configuration comprises a retailer server 128 that enables the retailer 125 to communicate using the network 110 and to host the digital contents utilizing simulated packages. In some instances, the retailer server 128 is coupled to a package database 130 that the retailer 125 uses to store the various simulated packages generated for a particular set of digital contents.

In some instances, the retailer 125 communicates in a separate transaction with the digital rights holder 145 to receive the digital content and to receive permission to host the digital content. In such instances, the retailer 125 generates its own simulated packages for the digital content obtained from the digital rights holder 145. In other instances, the retailer 125 may communicate in a separate transaction with the digital rights holder 145 to receive both the digital content and simulated packages (that were generated by the digital rights holder 145) for the digital content. In some instances, the retailer 125 may also receive such digital content and/or network-based simulated packages from a management server (e.g., 115) that is connected to the overall setup through the network 110.

The retailer 125, in some instances, incorporates an authentication database 134. The authentication database 134, for example, stores access rights and permissions associated with various users. In one exemplary embodiment, the retailer server 128 receives a request to display the outer package level of a simulated package to a user. The retailer server 128 displays the outer package level and allows the user to enter authentication information to gain access to the inner content level of the simulated package. The authentication database 134 maintains relevant authentication information associated with the users to enable the users to gain access to the inner content level of the simulated package. In one embodiment, the retailer server 128 also includes a purchasing agent 132, which will be explained in detail with reference to the management server 115 discussed below.

It is noted that the retailer 125 can either host the simulated packages and the digital content by operating a local retailer server (e.g., 128), or can use a third party server (not shown in FIG. 1) to perform such services. The term “retailer server” as used herein refers to any mechanism associated with the retailer that operates to receive requests on behalf of the retailer and present simulated packages in response to such requests. Additionally, it is understood that FIG. 1 can include one or a plurality of retailers hosting digital content and simulated packages on behalf of one or a plurality of digital rights holders.

The management server 115 of FIG. 1 includes a computing server 118 that is configured to receive requests through the network environment. The computing server 118 of the management server 115 is also configured to generate and maintain unique identifiers for each of the simulated packages hosted by, for example, the retailer server. The management server utilizes a package ID database 120 to store and maintain the identifiers associated with each of the simulated packages. In some instances, the package ID database 120 comprises information associating each identifier (of the simulated packages) with at least one specific retailer currently hosting the simulated package. In one exemplary and non-limiting embodiment, the package ID database is in the form of a lookup table associating the identifiers with the retailers.

In one embodiment, the retailer 125 requests the management server 115 to generate one or a plurality of identifiers for each of the simulated packages that the retailer intends to host (subsequent to receiving relevant permission and/or digital content from the digital rights holder 145). Upon receiving the request, the computing server 118 of the management server 118 generates the requested number of identifiers. The management server 115 stores the generated identifiers in the package ID database 120. The management server 415 also maintains information about the retailer associated with each identifier (e.g., within a lookup table maintained by the package ID database 120).

In some instances, when a user clicks on a link associated with a particular simulated package (from, for example, the user's personal computing device 101), the request is received by the computing server 118 of the management server 115. As will be explained in greater detail below, the link usually incorporates the unique identifier of the simulated package (that the link is originally associated with).

When the request is received by the management server 115, it identifies the retailer (e.g., 125) currently hosting the particular simulated package (based on the information maintained within the package ID database 120). Upon identifying the retailer, the management server 115 transfers the user to the retailer server 128. Subsequent to the transfer, in some instances, the retailer server 128 responds by presenting the outer package level of the simulated package to the user. In one embodiment, the management server utilizes a representational state transfer (REST) type of protocol to perform the lookup and transfer operations explained herein. Other protocols known to people of ordinary skill in the art may also be utilized to perform the above functions of the management server.

Consider the following illustration, which presents one scenario of presenting the package: a retailer server 128, in the process of fulfilling a sale, removes an ID from the list of (as yet unsold) IDs previously generated by the management server 115 in response to a wholesale purchase by that retailer. This, in effect, takes a simulated package out of inventory for sale (reducing inventory by one). The underlying theory is that the management server 115 creates package instances by generating globally unique IDs. These IDs, once transferred to a retailer (but not yet sold), represent unique package instances sitting in retailer inventory. Fulfilling a sale to a specific end customer means removing an ID from the list of as-yet unsold IDs (the retailer inventory of a title) and associating it with the end customer in a database hosted by the retailer. This database allows the retailer to link an authenticated user to the packages they are authorized to see. Note that only the retailer knows who bought the package with a particular ID at retail and only the management server knows which retailer bought the package with a particular ID at wholesale. In the simplest case, a link looks like “lyryq.com/nnnnnnn” and only the retailer can determine whether a “click” is coming from an actual purchaser or a prospective purchaser (by soliciting authentication and checking nnnnnnn against the package database.

FIG. 2 depicts an exemplary embodiment of a simulated package 200. As discussed above, each simulated package 200 has an outer package level 205 and an inner content level 235. The simulated package 200 may be considered, for example, as a container to bundle digital objects and present the bundled digital objects to the user in the form of a two-tiered package format. The two-tiered package format includes an outer cover layer and an inner content layer. The outer package level (i.e., the outer cover layer) 205 operates as a concealment layer hiding digital objects enclosed within the simulated package.

In some instances, the outer package level presents ancillary information related to the digital objects on the cover. Such ancillary information may function as a marketing tool for the digital products (that are enclosed or bundled within the simulated package 200), provide aesthetic appeal, or may simply operate as a placeholder to enable a user to transition to the inner digital contents of the simulated package. It is noted that the information presented on the outer package level 205 may also be completely unrelated to the digital objects bundled within the simulated package 200. In some instances, the ancillary information may be presented in the form of a plurality of icons displayed on the outer package level 205.

Examples of information presented on the outer package level 205 include graphical images 206, any type of decorative or informative textual information 207, animated graphics 210, etc. In some instances, the outer package level may include samples 212 or previews 209 of the digital objects embedded within the simulated package 200. The samples 212 or previews 209 may depend on the format of the digital objects (e.g., a ten second streaming music clip extracted from an MP3 music file embedded within the simulated package 200, a trial version of a software executable file embedded within the simulated package 200, etc.).

The outer package level 205 may also include a feature by which the user can initiate a transition to the inner content level 235 of the simulated package 200. For example, the outer package level 205 may include a purchase or open button 211 that a user can click on to open the simulated package 200 and reveal the inner digital contents of the simulated package 200. In some instances, the outer package level 205 may also include a provision through which a user can enter authentication information to enable a transition to the inner content level 235 of the simulated package 200. The outer package level 205 may also, in some instances, incorporate ambient music.

In some instances, the outer package level 205 is in the form of a webpage that can be viewed using a web browser of a user's terminal device. In other instances, the outer package level may be viewed by means of a standalone application (i.e. an application adapted to viewing simulated packages independently of a web browser) that may be installed on a user's terminal device. The outer package level 205 is public, meaning that a user need not have a proprietary interest in the simulated package 200 to be able to view the outer package level or to access the information offered on the outer package level 205.

In one embodiment, when the user clicks on the open button 211 of the outer package level 205, the simulated package 200 initiates a transition to reveal the inner content level 235 of the simulated package 200. The revealing, in some instances, may be preceded by an animated transition or a recorded sound such as a click to provide to the user a simulated effect of opening of a physical package. In contrast to the outer package level, the inner content level 235 has restricted access and accordingly is not publicly available to users. A user would have to have previously gained proprietary interest in the simulated package 235 to be able to gain access to the inner content level 235. As with the outer package level 205, the inner content level 235 may be presented to the user as a distinct webpage within a web browser of a user's terminal device, or may be viewed by means of a standalone application (i.e. an application adapted to viewing simulated packages independently of a web browser) that may be installed on a user's terminal device.

In one embodiment, the inner content level 235 provides a list of digital objects 240 embedded within the simulated package 200. In some instances, the inner content level 235 may also include a media player interface 250 to enable the user to perform operations on the digital objects contained within the inner content level 235. For example, where the digital objects are audio files (e.g., MP3 music files), the media player interface 250 is in the form of an audio player to enable the user to playback the MP3 files using the media player interface 250.

Additionally, the inner content level 235 may also include privileges 242, proxies 244, and promotions 246 associated with the digital objects embedded in the simulated package 200. Such privileges 242, proxies 244, and promotions 246 further embellish a physical package experience for the benefit of the user. The privileges 242 represent, for example, benefits that the user gains from the digital rights holder (of the digital objects embedded in the simulated package 200) or the retailer (hosting the simulated package) by virtue of the user's proprietary interest in the simulated package 200.

The privileges 242 could include, for example, an opportunity to participate in an interactive cyber-chat session with the artists of audio tracks embedded in the simulated package 200. Other privileges 242 could include, for example, a future sneak preview of an album by the artists prior to public availability. Other such privileges 242 include opportunities or rights that a user gains by virtue of his proprietary interest in the simulated package that allow him to partake in events normally not available to the general public.

Proxies 244 are digital representations or substitutes for a physical article that the user gains by virtue of his proprietary interest in the simulated package 200. The proxies 244 function as a certificate of authenticity or proof of purchase for a physical product associated with the simulated package 200. Such physical products may include, for example, a book or a t-shirt related to the digital objects in the simulated package 200. In some instances, the simulated package 200 may contain proxies for physical products alone without containing any other types of digital objects. The user may then use these proxies 244 to obtain the physical product by, for example, exchanging the proxies 244 for the associated physical products.

In one embodiment, the inner content level 235 may be represented in the form of a digital media composite or a standardized digital media file format (e.g., a connected media experience, or CMX format, an iTunes LP format, a MusicDNA format, etc.), such outer package level 205 enables access to the inner digital media composite included or represented as the inner content level 235.

FIG. 3 is an exemplary snapshot of the outer package level and inner content level of a simulated package. This snapshot is an example of a simulated package used to bundle digital audio files (MP3 files).

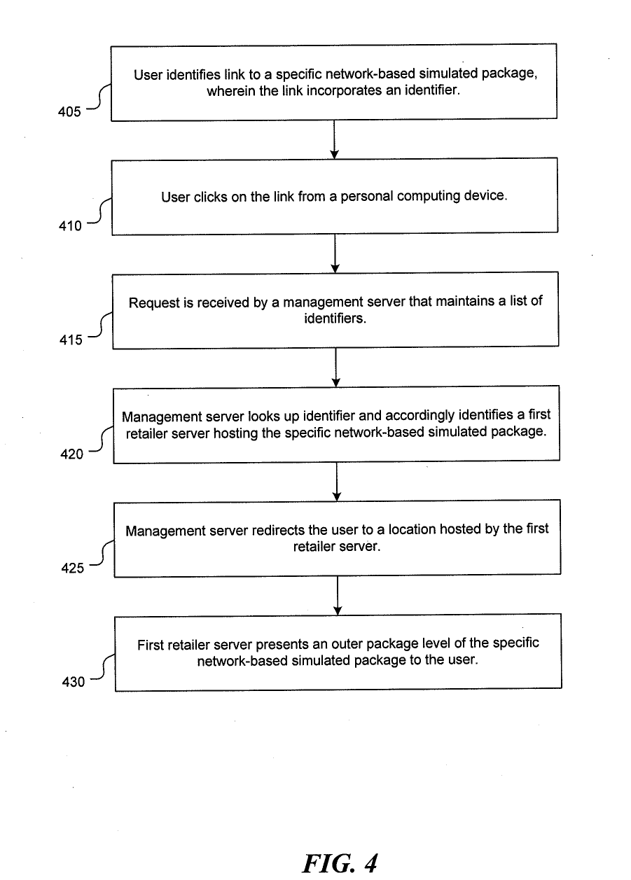

FIG. 4 is a flow diagram depicting a method by which a user can access the contents of a simulated package. In one embodiment, a user first identifies a link to a specific simulated package 405. The link, as explained above, includes a unique identifier associating the specific simulated package with a first retailer server hosting the specific simulated package. The user clicks on the link using a personal network terminal device 410. Upon clicking on the link, the request to view the specific simulated package is received by a management server connected to the computing device through a network environment 415. The management server maintains a list of identifiers of all simulated packages. The management server also maintains, for example, a lookup table to associate the identifiers with their respective retailer servers.

When the management server receives the request, the management server extracts the identifier information from the link. The management server looks up the identifier against the look up tables to identify a first retailer server currently hosting the specific simulated package 420. Upon identifying the first retailer server, the management server transfers the request from the user to the retailer server hosting the specific simulated package 425. The retailer server bypasses any SKU information associated with purchase of the specific retailer server, and directly displays the outer package level of the specific simulated package to the user 430.

The link mentioned above may be generated and utilized in one of several ways. In some instances, before a user purchases an instance of a particular product enclosed in a simulated package, the link may point to a generic outer package level of the particular product hosted by the retailer server, generic in this case meaning without an assigned identifier. In such instances, information about the user or an identity of the user is not incorporated within the link. The user may then click on this link to be directly redirected to the outer package level of the particular simulated package. The user may then purchase an instance of the particular product by using the purchase option provided in the generic outer package level.

In some instances, upon the user's purchasing the particular product enclosed in a simulated package, the retailer server generates a new link (or an updated link). The new or updated link now includes identifier information associating the particular simulated package with both the retailer server and the user. One of the advantages of having a personalized link to the particular simulated package is that the purchasing step is bypassed when the user clicks on the link from anywhere within the network environment. The user would only have to provide relevant authentication information to transition to the inner content level of the particular simulated package from the outer package level.

The use of individualized links for the simulated packages presents additional advantages. The following section describes a non-limiting example of one such advantage. A first bona fide user of a first simulated package (i.e., the first user has purchased the first simulated package) is presented with a first link that is uniquely assigned to the first user. In one embodiment, the outer package level may include a “forward” option to enable the first user to forward the first link to other users. The first user may then forward the first link to a second user using such a “forward” option. The first link, upon being forwarded, may be slightly modified or updated (creating a second link) to help the management server realize that the second link is a forwarded version of the first link. The second link, in some instances, would still retain the identity of the first bona fide user.

When the second user clicks on the forwarded link (i.e., the second link), the management server (connected to the second user's computing device through the network environment) receives the request. The management server then transfers the second user to the specific retailer server hosting a second simulated package (which, for example, is a duplicate instance of the first simulated package). At this point, the second simulated package is not yet uniquely associated with any user. The outer package level of the second simulated package presents a purchase option to the second user. Upon the second user purchasing the second simulated package, the retailer server associates the identifier corresponding to the second simulated package with the second user. The retailer server may also generate an updated link that uniquely associates the second simulated package with the second user.

In some instances, because the second link includes information about the first user that forwarded the link, the retailer server may assign gratitude credit to the first user. The gratitude credit, for example, may include addition of proxies, promotions, or privileges within the inner package level of the first simulated package (that is uniquely associated with the first user). Other means by which the first user can be assigned credit for the forwarded second link, as understood by people of ordinary skill in the art, are equally applicable here.

In some embodiments, an operator of the management server may generate revenue for the lookup and transfer services (as discussed above) in one of several ways. For example, in one instance, the operator of the management server may charge a standard flat fee to a particular retailer server (or the relevant digital rights holder) for every user-click redirected to that particular retailer server. In another example, the operator of the management server may charge the digital rights holder for every lookup and transfer operation that resulted in a successful purchase of a simulated package. Other means of revenue generation, as would be understood and known to people of ordinary skill in the art, are equally applicable here.

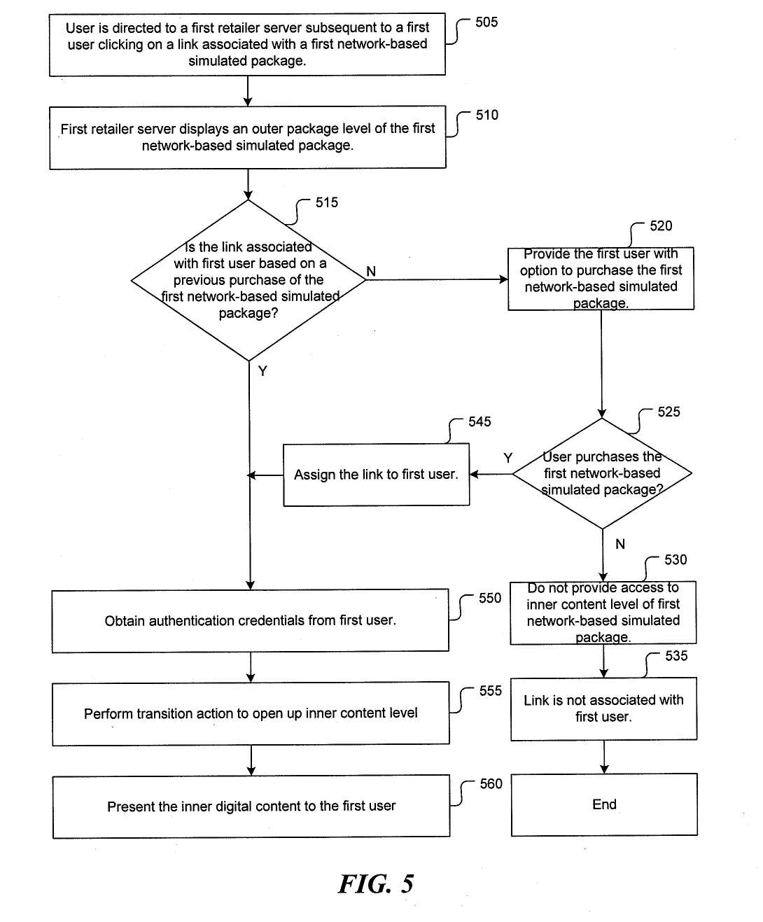

FIG. 5 is a flow diagram illustrating a method by which the digital contents embedded in a simulated package are made available to a user. In one embodiment, as indicated above, a first user is redirected to a first retailer sever hosting a first simulated package when a first user clicks on a link associated with the first simulated package 505. When the first retailer server receives the request, it presents the outer package level of the first simulated package to the first user 510. At this point, in some instances, the retailer server examines whether the link is associated with the user based on a previous purchase of the first simulated package by the user 515. If the first retailer server determines that the user is a bona fide purchaser of the first simulated package, it provides an option to the first user to enter his/her authentication information 550.

In some instances, where the link is not associated with the first user (because the first user is not the owner of the first simulated package), the retailer server provides the first user with an option to purchase the first simulated package 520. If the first user does purchase the first simulated package, as indicated in 525, the link is uniquely associated with the user 545. The flow then transfers again to 550, where the outer package level permits the first user to enter relevant authentication information. If the first user does not purchase the first simulated package, the retailer server does not provide the first user with access to the inner content level of the first simulated package 530 and does not associate the link with the first user 535.

If the user has already purchased the first simulated package, the retailer server obtains authentication information from the first user 550. Upon verifying the authentication information, the retailer server performs a transition action to reveal 555 the inner content level of the first simulated package to the first user 560.

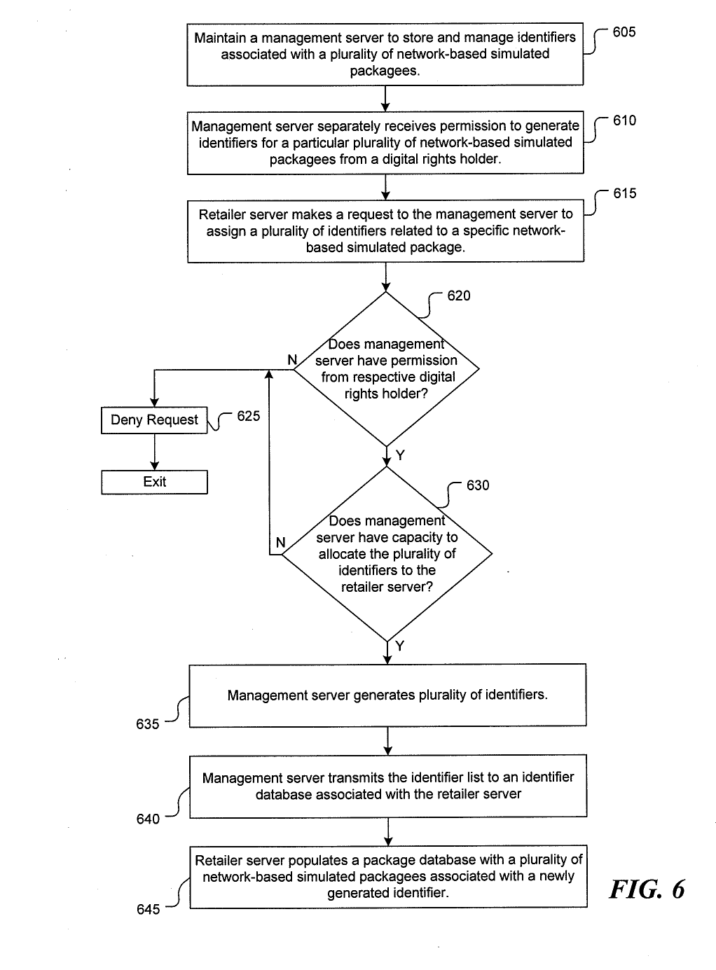

FIG. 6 is a flow diagram depicting a method by which a management server generates and maintains identifiers for the simulated packages. The method starts with using a management server to store and manage identifiers associated with multiple simulated packages 605. Using an offline transaction with a digital rights holder, the management server, in some instances, receives permission from the digital rights holder to generate identifiers for the multiple simulated packages 610. As indicated in 615, a retailer server may then request the management server to generate a set of new identifiers for a particular simulated package the retailer server will be hosting.

The management server, in some instances, performs two verifications to ensure that it can generate the set of new identifiers. The management server first verifies whether it has the permission from the appropriate digital rights holder to generate the set of new identifiers 620. The management server also verifies whether it has the capacity (e.g., sufficient space in the ID database of the management server, etc.) to generate the set of new identifiers 630. If either of these verifications fails, the management server denies the request from the retailer server to generate the set of new identifiers 625.

If both the verifications pass, the management server generates the set of new identifiers 635 and transmits the set of new identifiers to an identifier database associated with the retailer server 640. In some instances, the retailer server populates an associated package database with duplicates of the particular simulated package to match the number of identifiers in the set of new identifiers generated by the management server 645.

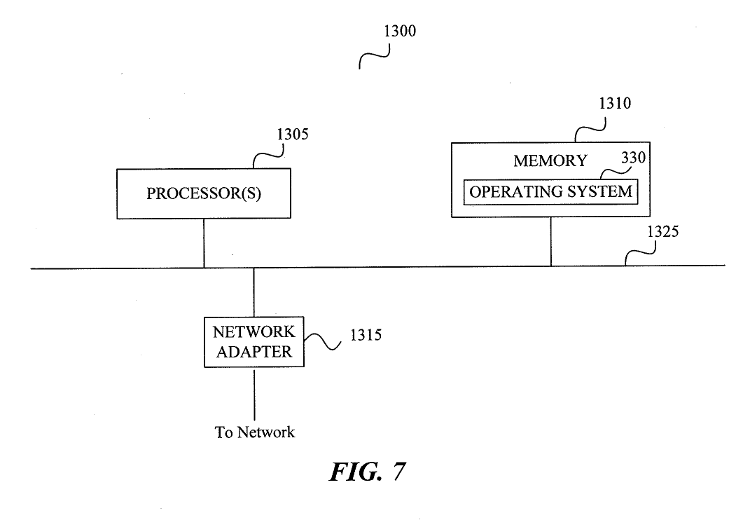

FIG. 7 is a high-level block diagram showing an example of the architecture for a computer system 1300 that can be utilized to implement a management server (e.g., 115 from FIG. 1), a retailer server (e.g., 125 from FIG. 1), etc. In FIG. 8, the computer system 1300 includes one or more processors 1305 and memory 1310 connected via an interconnect 1325. The interconnect 1325 is an abstraction that represents any one or more separate physical buses, point to point connections, or both connected by appropriate bridges, adapters, or controllers. The interconnect 1325, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire”.

The processor(s) 1305 may include central processing units (CPUs) to control the overall operation of, for example, the host computer. In certain embodiments, the processor(s) 1305 accomplish this by executing software or firmware stored in memory 1310. The processor(s) 1305 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1310 is or includes the main memory of the computer system 1100. The memory 1310 represents any form of random access memory (RAM), read-only memory (ROM), flash memory (as discussed above), or the like, or a combination of such devices. In use, the memory 1310 may contain, among other things, a set of machine instructions which, when executed by processor 1305, causes the processor 1305 to perform operations to implement embodiments of the present invention.

Also connected to the processor(s) 1305 through the interconnect 1325 is a network adapter 1315. The network adapter 1315 provides the computer system 1300 with the ability to communicate with remote devices, such as the storage clients, and/or other storage servers, and may be, for example, an Ethernet adapter or Fiber Channel adapter.

The algorithms and software presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from other portions of this description. In addition, the present invention is not described with reference to any particular programming language, and various embodiments may thus be implemented using a variety of programming languages.

The systems corresponding to the methods explained above and associated embodiments relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system.

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

1. A system for bundling and presenting digital information in a network environment, the system comprising:
a processor configured to operate a plurality of network-based simulated packages for bundling and presenting digital information in the network environment, each of the plurality of network-based simulated packages including:
an outer package level configured to bundle a plurality of digital objects and to present ancillary information related to the plurality of digital objects, each of the plurality of digital objects incorporating digital information in which a digital rights holder has rights or interests; and
an inner content level configured to present the plurality of digital objects to a first user in a bundled format subsequent to the first user performing a transition action on the outer package level;
wherein, each of the plurality of network-based simulated packages includes an identifier configured to uniquely identify a combination of the outer package level and the inner content level, enabling each of the plurality of network-based simulated packages to:
function as a unique instance within the network environment; and
be uniquely associated with a specific user.

2. A system for bundling and presenting digital information in a network environment as recited in claim 1, wherein the ancillary information included in the outer package level includes at least one of:
graphics related to the plurality of digital objects;
advertising information;
ambient animation including information related to the plurality of digital objects;
ambient music;
samples of one or more of the plurality of digital objects; or
game play associated with the plurality of digital objects.

3. A system for bundling and presenting digital information in a network environment as recited in claim 1, wherein the plurality of digital objects include at least one of:
digital audio files;
digital video files; or
software installation files;
electronic books.

4. A system for bundling and presenting digital information in a network environment as recited in claim 1, wherein the inner content level includes a media operator configured to enable the first user to perform operations upon the plurality of digital objects.

5. A system for bundling and presenting digital information in a network environment as recited in claim 1, wherein, in addition to the plurality of digital objects, the inner content level of a specific network-based simulated package associated with the first user includes at least one of:
a proxy;
a promotion; or
a privilege.

6. A system for bundling and presenting digital information in a network environment as recited in claim 4, wherein the proxy includes a certificate of ownership to enable the first user to acquire ownership of a physical product offered in association with the specific network-based simulated package.

7. A system for bundling and presenting digital information in a network environment as recited in claim 4, wherein the privilege grants the first user a right or a priority to partake in an event offered by the digital rights holder in conjunction with the first user's ownership interest in the specific network-based simulated package.

8. A system for bundling and presenting digital information in a network environment as recited in claim 1, wherein the transition action performed by the first user includes entering authentication information by initiating an action through the outer package level to enable the first user to gain access to the plurality of digital objects embedded in the inner content level.

9. A system for bundling and presenting digital information in a network environment as recited in claim 1, wherein the transition action includes an animated transition connecting the outer package level and the inner content level.

10. A system for bundling and presenting digital information in a network environment as recited in claim 1, wherein the combination of the outer package level and the inner content level of a specific network-based simulated package represents a dual-level presentation of a single instance of the specific network-based simulated package.

11. A system for bundling and presenting digital information in a network environment as recited in claim 1, wherein the identifier included in a specific network-based simulated package uniquely associates the specific network-based simulated package with a particular user who has acquired a proprietary interest in the specific network-based simulated package.

12. A system for bundling and presenting digital information in a network environment as recited in claim 11, wherein the particular user loses proprietary interest in the specific network-based simulated package upon stripping the plurality of digital objects away from the inner content level of the specific network-based simulated package.

13. A system for bundling and presenting digital information in a network environment as recited in claim 12, wherein the particular user retains a proprietary interest in the plurality of digital objects that were stripped from the inner content level of the specific network-based simulated package, but not to the specific network-based simulated package.

14. A system for bundling and presenting digital information in a network environment as recited in claim 1, wherein the outer package level is openly accessible by any user within the network environment, and wherein a particular user's access to the inner content level is restricted based on the particular user's ownership interest in the network-based simulated package.

15. A system for bundling and presenting digital information in a network environment as recited in claim 1, wherein the inner content level is a standardized digital medial composite.

16. The system of claim 16, wherein the standardized digital media composite is a CMX (connected media experience) file.

17. A method implemented using a management server, the management server configured to enable bundling and packaging of digital information within a network environment, the method comprising:
maintaining a plurality of identifiers, each of the plurality of identifiers uniquely identifying and associated with a network-based simulated package hosted by a retailer server, wherein the network-based simulated package includes an outer package level to present ancillary information related to digital objects embedded within the network-based simulated package and a inner content level to present the embedded digital objects to a user;
receiving a request to access a first network-based simulated package subsequent to a first user clicking on a link related to the first network-based simulated package, wherein the link incorporates a first identifier associated with the first network-based simulated package, and wherein the request is routed to the management server from the first user using a communication protocol of the network environment; and
redirecting the first user to a specific retailer server hosting the first network-based simulated package as indicated by the first identifier, wherein subsequent to the redirection, the specific retailer server presents the outer package level of the first network-based simulated package to the first user.

18. A method implemented using a management server as recited in claim 17, the method further comprising:
receiving a request from a first retailer server to assign a subplurality of identifiers to the first retailer server; and
generating the subplurality of identifiers; and
transmitting the subplurality of identifiers to the first retailer server, each of the subplurality of identifiers associating a particular network-based simulated package with the first retailer server.

19. A method implemented using a management server as recited in claim 18, wherein the management server acquires permission to generate the subplurality of identifiers from a digital rights holder of the digital objects embedded in each of the network-based simulated packages associated with the subplurality of identifiers.

20. A method implemented using a management server as recited in claim 18, wherein the first retailer server generates the outer package level and the inner content level associated with the particular jewel box, and wherein the first retailer server acquires the digital objects to be embedded in the inner content level from a digital rights holder of the digital objects.

21. A method implemented using a management server as recited in claim 17, wherein the specific retailer server displays to the first user the outer package level of the first network-based simulated package subsequent to the first user getting redirected to the specific retailer server, further wherein the ancillary information included in the outer package level includes at least one of:
graphics related to the embedded digital objects;
advertising information;
ambient animation including information related to the embedded digital objects;
ambient music;
samples of one or more of the embedded digital objects; or
game plays associated with the embedded digital objects.

22. A method implemented using a management server as recited in claim 21, wherein the specific retailer server provides the inner content level of the first network-based simulated package subsequent to the first user entering authentication information through the outer package level of the first network-based simulated package.

23. A method implemented using a management server as recited in claim 18, wherein the outer package level of the first network-based simulated package includes a purchase link to enable the first user to purchase and acquire a proprietary interest in the first network-based simulated package.

24. A method implemented using a management server as recited in claim 23, wherein the retailer server redirects the first user to a payment transaction section of the retailer server subsequent to the first user clicking on the purchase link.

25. A method implemented using a management server as recited in claim 24, wherein the retailer server uniquely assigns the first identifier to the first user subsequent to the first user successfully completing the payment transaction section.

26. A method implemented using a management server as recited in claim 21, wherein the management server periodically transmits to the digital rights holder an accounting of the number of identifiers generated for a particular class of digital objects owned by the digital rights holder.

27. A method implemented using a management server as recited in claim 17, wherein the link is available to the first user through a computing device associated with the first user.

28. A method implemented using a management server as recited in claim 27, wherein the link incorporates the first identifier associated with the first network-based simulated package and includes one or more of: information related to the specific retailer server hosting the first network-based simulated package; and information related to the first user having a proprietary interest in the first network-based simulated package.

29. A method implemented using a management server as recited in claim 17, wherein the link is generated by the specific retailer server.

30. A method implemented using a management server as recited in claim 17, wherein the management server charges either the digital rights holder or the retailer a flat fee for redirecting the link from the first user to the retailer server.

31. A method implemented using a management server as recited in claim 17, wherein the management server charges either the digital rights holder or the retailer a referral fee subsequent to the first user purchasing the first network-based simulated package.

32. A method implemented using a management server as recited in claim 17, wherein the retailer server enables the first user to forward the link to a second user.

33. A method implemented using a management server as recited in claim 32, wherein the retailer server presents an outer package level of a second network-based simulated package subsequent to the second user clicking on the forwarded link.

34. A method implemented using a management server as recited in claim 33, wherein the retailer server generates a second link uniquely associated with the second user subsequent to the second user acquiring an ownership interest in the second network-based simulated package.

35. A method implemented using a management server as recited in claim 34, wherein the retailer server or the digital rights holder presents the first user a gratitude credit subsequent to the second user acquiring an ownership interest in the second network-based simulated package.

36. A method implemented using a management server as recited in claim 35 wherein the gratitude credit to the first user includes at least one of:
a second promotion added to the inner content level of the first network-based simulated package;
a second privilege added to the inner content level of the first network-based simulated package; or
a second proxy added to the inner content level of the first network-based simulated package.
A second digital media object added to the first VJB.

37. A computer implemented method for bundling and presenting digital information in a network environment, the computer implemented method comprising:
bundling a plurality of digital objects within a plurality of network-based simulated packages, each of the plurality of digital objects incorporating digital information in which a digital rights holder has rights or interests;
presenting ancillary information related to the plurality of digital objects using an outer package level of each of the plurality of network-based simulated packages;
presenting the plurality of digital objects to a first user using an inner content level of each of the plurality of digital boxes, subsequent to the first user performing a transition action on the outer package level;
assigning an identifier to each of the plurality of network-based simulated packages to uniquely identify a combination of the outer package level and the inner content level, thereby enabling each of the plurality of network-based simulated packages to:
function as a unique instance within the network environment; and
be uniquely associated with a specific user.

38. A computer implemented method for bundling and presenting digital information in a network environment as recited in claim 37, wherein the ancillary information included in the outer package level includes at least one of:
graphics related to the plurality of digital objects;
advertising information;
ambient animation including information related to the plurality of digital objects;
ambient music;
samples related to one or more of the plurality of digital objects; or
game play associated with the plurality of digital objects.

39. A computer implemented method for bundling and presenting digital information in a network environment as recited in claim 37, wherein each of the plurality of digital objects includes at least one of:
digital audio files;
digital video files;
software installation files; or
electronic books.

40. A computer implemented method for bundling and presenting digital information in a network environment as recited in claim 37, wherein the inner content level includes a media operator configured to enable the first user to perform operations upon the plurality of digital objects.

41. A computer implemented method for bundling and presenting digital information in a network environment as recited in claim 37, wherein, in addition to the plurality of digital objects, the inner content level of a specific network-based simulated package associated with the first user includes at least one of:
a proxy;
a promotion; or
a privilege.

42. A computer implemented method for bundling and presenting digital information in a network environment as recited in claim 37, wherein the transition action performed by the first user includes entering authentication information through the outer package level to enable the first user to gain access to the plurality of digital objects embedded in the inner content level.

43. A computer implemented method for bundling and presenting digital information in a network environment as recited in claim 37, wherein the identifier included in a specific network-based simulated package uniquely associates the specific network-based simulated package with a particular user who has acquired a proprietary interest in the specific network-based simulated package.

44. A computer implemented method for bundling and presenting digital information in a network environment as recited in claim 43, wherein the particular user loses proprietary interest in the specific network-based simulated package upon stripping the plurality of digital objects away from the inner content level of the specific network-based simulated package.

45. A computer implemented method for bundling and presenting digital information in a network environment as recited in claim 44, wherein the particular user retains a proprietary interest in the plurality of digital objects that were stripped from the inner content level of the specific network-based simulated package, but not to the specific network-based simulated package.

46-53. (canceled)

54. A system for bundling and presenting digital music in a network environment, the system comprising:
a processor configured to operate a plurality of network-based simulated packages for bundling and presenting digital music in the network environment, each of the plurality of network-based simulated packages including:
an outer package level configured to bundle a plurality of digital music objects and to present ancillary information related to the plurality of digital music objects, each of the plurality of digital music objects incorporating a musical score in which a digital rights holder has rights or interests; and
an inner content level configured to present the plurality of digital music objects to a first user in a bundled format subsequent to the first user performing a transition action on the outer package level;
wherein, each of the plurality of network-based simulated packages includes an identifier configured to uniquely identify a combination of the outer package level and the inner content level, enabling each of the plurality of network-based simulated packages to:
function as a unique instance within the network environment; and
be uniquely associated with a specific user.

55. A system for bundling and presenting digital music in a network environment as indicated in claim 54, wherein the outer content level comprises one or more of:
samples of musical scores from one or more of the plurality of digital music objects;
ambient music related to one or more of the plurality of digital music objects;
audio information related to artists of the musical scores from one or more of the plurality of digital music objects;
image information related to artists of the musical scores from one or more of the plurality of digital music objects; or
video information related to artists of the musical scores from one or more of the plurality of digital music objects.

56. A system for bundling and presenting digital music in a network environment as indicated in claim 54, wherein the inner content level further comprises one or more of:
a media player configured to playback the musical scores from one or more of the plurality of digital music objects;
a privilege; or
a proxy.

57. A system for bundling and presenting digital music in a network environment as indicated in claim 56, wherein the privilege is a right to participate in an exclusive online event related to the plurality of digital music objects, wherein the exclusive online event is offered from within the inner content level of the network-based simulated package.

58. A system for bundling and presenting digital music in a network environment as indicated in claim 54, wherein each of the plurality of digital music objects is an mp3 music file.

59. A system for bundling and presenting digital music in a network environment as indicated in claim 54, wherein each of the plurality of digital music objects is a music file in a streaming format.

60-86. (canceled)
